(19) United States
(12) Patent Application Publication
(10) Pub. No.: US 2026/0326841 A1
(43) Pub. Date: Oct. 22, 2026

(54) SELF-STABILIZING OMNIDIRECTIONAL MOBILE ROBOT AND MOBILE DEVICE

(71) Applicant: HangZhou YuShu TECHNOLOGY CO.,LTD., Hangzhou (CN)

(72) Inventors: Xingxing WANG, Hangzhou (CN); Kai WANG, Hangzhou (CN)

(21) Appl. No.: 19/115,494

(22) PCT Filed: Jun. 29, 2023
(86) PCT No.: PCT/CN2023/103693

§ 371 Date: Mar. 26, 2025

(30) Foreign Application Priority Data
Oct. 13, 2022 (CN) 202211253197.0

(51) Int. Cl. B62D 57/028; B60B 33/00; B62D 63/04

(52) U.S. Cl. CPC B62D 57/028; B60B 33/0068; B62D 63/04

(57) ABSTRACT

Provided are a self-stabilizing omnidirectional mobile robot and a mobile device. The self-stabilizing omnidirectional mobile robot comprises a robot body (1), a power system, and a wheel (2), wherein the power system comprises a first power unit (3), a leg unit (4), a second power unit (5), a leg end portion (6), and a third power unit (7) connected in sequence, the first power unit (3) is provided on the robot body (1) to drive the leg unit (4) to swing in a vertical plane relative to the robot body (1). The first power unit (3) is provided at a hip joint of each leg to control the leg unit (4) to swing up and down vertically, thereby driving the wheel (2) to move up and down vertically, enabling the robot body (1) to effectively maintain a fixed posture through up-down movement of the wheel (2) when encountering an obstacle or a depression during movement.

### TECHNICAL FIELD

The present invention relates to the technical field of robots, and in particular to a self-stabilizing omnidirectional mobile robot and a mobile device.

### BACKGROUND

Currently, most of existing wheeled robots adopt passive spring-damping suspensions to improve their ability to pass over uneven terrains. However, such suspensions lead to very limited mobility in complex terrains, and fluctuations in the posture of an entire robot body may still occur, failing to enable the robot body to maintain a fixed posture. Moreover, a conventional steering mechanism of the wheeled robot is incapable of achieving flexible movement of full degrees of freedom, such as forward, backward, left and right translations or in-place turns. Furthermore, the existing wheeled robot is unable to jump over a trench or an obstacle, and is also unable to climb stairs.

The Chinese patent application No. 2017113762204 discloses a wheeled robot including a chassis housing, wherein a motor and a steering linkage connected thereto are provide on the chassis housing, a suspension assembly that is connected to the steering linkage and used to drive a wheel to rotate along a vertical axis is provide on the chassis housing, and the center of a line connecting the centers of rotation of the wheels coincides with the center of the chassis housing. The wheeled robot employs the linkage to drive the wheel to achieve steering. Although a suspension system is used on the wheeled robot to reduce the impact of an uneven terrain on a robot body, the robot body cannot be maintained at a fixed posture.

The information disclosed in the Background is used only for understanding the background of the conception of the present invention, and thus may include information that does not constitute the prior art.

### SUMMARY

In view of the above problems or one of the above problems, the first purpose of the present invention is to provide a self-stabilizing omnidirectional mobile robot and a mobile device, enabling a robot body to maintain a specific position and posture through up-down movement of a wheel during a pass over an obstacle or an uneven terrain.

In view of the above problems or one of the above problems, the second purpose of the present invention is to provide a self-stabilizing omnidirectional mobile robot, wherein a first power unit is provided at a hip joint of each leg to control a leg unit to swing up and down, thereby driving a wheel to move up and down, enabling a robot body to effectively maintain a fixed posture through up-down movement of the wheel when encountering an obstacle or a depression during movement; a second power unit is provided at a knee joint of each leg, to drive 360-degree omnidirectional steering of the wheel, avoiding the limitation of a steering angle imposed by a conventional steering mechanism and thereby making the movement more flexible; a third power unit is provided at the wheel, directly converting output of the third power unit into kinetic energy for advancing of the wheel, resulting in higher transmission efficiency; and through cooperation between the first power unit at the hip joint, the second power unit at the knee joint, and the third power unit driving the rotation of the wheel, the posture of the robot body can be fixed in any state, enabling adaptation to different complex terrains such as stairs and grass.

In view of the above problems or one of the above problems, the third purpose of the present invention is to provide a mobile device, wherein a first power unit is provided on a robot body to control a leg unit to swing up and down, thereby driving a wheel to move up and down, enabling the robot body to maintain a fixed posture as far as possible through up-down movement of the wheel when encountering an obstacle or a depression during movement, thereby reducing shaking of the robot body. The solution is simple and practical, and facilitates the production and manufacture.

In order to achieve one of the above purposes, the first technical solution of the present invention is as follows:
a self-stabilizing omnidirectional mobile robot, comprising a robot body, a power system, and a wheel, wherein the power system comprises a first power unit, a leg unit, a second power unit, a leg end portion, and a third power unit connected in sequence;
the first power unit is provided with a rotating shaft I and a fixed end I; one of the rotating shaft I and the fixed end I is provided on the robot body, and the other drives the leg unit to swing relative to the robot body in a vertical plane;
the third power unit is provided with a rotating shaft III and a fixed end III; one of the rotating shaft III and the fixed end III is provided on the leg end portion, and the other drives the wheel to rotate;

the second power unit is provided with a rotating shaft II for driving the leg end portion to rotate vertically along the axis thereof, so as to steer the wheel; and when the wheel encounters an obstacle, the leg unit is capable of swinging up and down, causing the wheel to swing up and down.

The power unit outputs relative rotational movement, so the rotating shaft and fixed end thereof are interchangeable.

The vertical swing or up-down swing includes, but is not limited to, movement in the vertical direction, movement in an inclined direction, pendulum-like reciprocating swing, vertical lifting, etc.

In the present invention, after continuous exploration and experimentation, the first power unit is provided at the hip joint of each leg to control the leg unit to swing up and down vertically, thereby driving the wheel to move up and down vertically, enabling the robot body to effectively maintain a fixed posture through up-down movement of the wheel when encountering an obstacle or a depression during movement; the second power unit is provided at the knee joint of each leg, to drive 360-degree omnidirectional steering of the wheel, avoiding the limitation of a steering angle imposed by a conventional steering mechanism and thereby making the movement more flexible; and the third power unit is provided at the wheel, directly converting output of the third power unit into kinetic energy for advancing of the wheel, resulting in higher transmission efficiency.

Furthermore, in the present invention, through cooperation between the first power unit at the hip joint, the second power unit at the knee joint, and the third power unit driving the rotation of the wheel, the posture of the robot body can be fixed in any state, enabling adaptation to different complex terrains such as stairs, grass, slopes, and other obstacles.

As an exemplary technical measure:
the leg unit comprises a thigh base, a thigh linkage, and a support seat, wherein the support seat is fixed on a housing of the second power unit and hinged to the thigh base; an output end of the first power unit is fixedly connected to the thigh base; one end of the thigh linkage is hinged to a housing of the first power unit or the robot body, and the other end is hinged to the support seat; the thigh base, the thigh linkage, and the support seat form a four-bar linkage driving the wheel to move up and down, and a steering axis of the wheel remains vertical relative to the ground, enabling the robot body to maintain a specific position and posture. The solution is feasible.

As an exemplary technical measure:
a pin shaft seat is fixed on the housing of the first power unit; the thigh linkage is rotatably connected to the first power unit or the robot body through the pin shaft seat; and a thigh cover plate is fitted to a side of the thigh base.

As an exemplary technical measure: the first power unit and/or the second power unit and/or the third power unit comprise a motor unit and a reduction unit, the housing of the second power unit is fixed on the leg end portion, and a housing of the third power unit is provided coaxially with the center of rotation of the wheel.

As an exemplary technical measure:
at least three sets of power systems and wheels are arranged on the robot body.

In order to achieve one of the above purposes, the second technical solution of the present invention is as follows:
a mobile device, comprising a robot body and a wheel, wherein
a first power unit and a leg unit are provided between the robot body and the wheel;
the first power unit is provided with a rotating shaft I and a fixed end I; one of the rotating shaft I and the fixed end I is provided on the robot body, and the other is fixed to the leg unit and capable of driving the leg unit to swing relative to the robot body;
the leg unit is provided with at least one rod member or/and plate member or/and support, and is equipped with the wheel; and
the wheel is capable of swinging up and down when the leg unit swings up and down, to avoid an obstacle and enable the robot body to maintain the desired position and posture.

The power unit outputs relative rotational movement, so the rotating shaft and fixed end thereof are interchangeable.

The up-down movement or vertical up-down movement in the present application may be up-down movement in the vertical direction, up-down movement in an inclined direction, pendulum-like up-down movement, or the like.

In the present invention, after continuous exploration and experimentation, the first power unit is provided on the robot body to control the leg unit to swing up and down, thereby driving the wheel to move up and down, enabling the robot body to maintain a fixed posture as far as possible through up-down movement of the wheel when encountering an obstacle or a depression during movement, thereby reducing shaking of the robot body. The solution is simple and practical, and facilitates the production and manufacture.

Furthermore, the wheel in the present invention can be lifted independently, so that the posture of the robot body can be fixed in any state, enabling the present invention to adapt to different complex terrains such as stairs, grass, slopes, and obstacles.

As an exemplary technical measure:
the leg unit is connected to the wheel through a leg end portion, forming a multi-joint structure; and
the leg end portion is a rod member or/and plate member or/and support, which is mounted on an inner side, an outer side, or two sides of the wheel.

Preferably, the leg end portion is a shank support, which is mounted on an outer side of the wheel.

The shank support has high structural strength, making it suitable for various scenarios. The shank support is mounted on the outer side of the wheel to effectively increase space between two opposing wheels, facilitating free rotation of the two wheels, avoiding mutual interference, and thereby making the structure of the present invention compact and small in size.

As an exemplary technical measure:
a second power unit is mounted between the leg unit and the leg end portion; and the second power unit is provided with a rotating shaft II and has a fixed end mounted on the leg unit, the rotating shaft II being fixed to the leg end portion.

The second power unit is provided at the knee joint of each leg, to drive 360-degree omnidirectional steering of the wheel, avoiding the limitation of a steering angle imposed by a conventional steering mechanism, and thereby making the movement more flexible.

### As an Exemplary Technical Measure:

a third power unit is mounted between the leg end portion and the wheel; and the third power unit is provided with a rotating shaft III and has a fixed end mounted on the leg end portion, the rotating shaft III being fixed to the wheel. The third power unit is provided at the wheel to directly convert the output of the third power unit into the kinetic energy for advancing of the wheel, resulting in higher transmission efficiency.

As an exemplary technical measure:
the axis of rotation of the second power unit is perpendicular to the axis of rotation of the first power unit; and the axis of rotation of the third power unit is perpendicular to the axis of rotation of the second power unit, enabling the wheel to rotate 360 degrees and to be lifted upward.

Through cooperation between the first power unit at the hip joint, the second power unit at the knee joint, and the third power unit driving the rotation of the wheel, the posture of the robot body can be fixed in any state, enabling adaptation to different complex terrains such as stairs and grass.

Furthermore, the first power unit, the second power unit, and the third power unit each may be a motor unit, a reduction unit, or a motor unit equipped with a reduction unit. The motor unit is a rotary motor; and the reduction unit is a reducer.

The present invention has the following beneficial effects:
In the present invention, after continuous exploration and experimentation, the first power unit is provided on the robot body to control the leg unit to swing up and down, thereby driving the wheel to move up and down, enabling the robot body to maintain a fixed posture as far as possible through up-down movement of the wheel when encountering an obstacle or a depression during movement, thereby reducing shaking of the robot body. The solution is simple and practical, and facilitates the production and manufacture.

Furthermore, the present invention provides the self-stabilizing omnidirectional mobile robot, wherein the first power unit is provided at the hip joint of each leg to control the leg unit to swing up and down vertically, thereby driving the wheel to move up and down vertically, enabling the robot body to effectively maintain a fixed posture through up-down movement of the wheel when encountering an obstacle or a depression during movement; the second power unit is provided at the knee joint of each leg, to drive 360-degree omnidirectional steering of the wheel, avoiding the limitation of a steering angle imposed by a conventional steering mechanism and thereby making the movement more flexible; and the third power unit is provided at the wheel, directly converting output of the third power unit into kinetic energy for advancing of the wheel, resulting in higher transmission efficiency.

Furthermore, in the present invention, through cooperation between the first power unit at the hip joint, the second power unit at the knee joint, and the third power unit driving the rotation of the wheel, the posture of the robot body can be fixed in any state, enabling adaptation to different complex terrains such as stairs and grass.

The present invention is further described in detail below with reference to the drawings and specific embodiments.

### BRIEF DESCRIPTION OF THE DRAWINGS

FIG. 1 is a schematic diagram of an overall structure according to the present invention;

FIG. 2 is a schematic structural diagram of a power system and a wheel according to the present invention;

FIG. 3 is an exploded view of the power system and the wheel according to the present invention;

FIG. 4 is a schematic structural diagram of a leg unit without a thigh cover plate according to the present invention;

FIG. 5 is a side view of the leg unit without the thigh cover plate according to the present invention;

FIG. 6 is a schematic diagram of a single wheel encountering an obstacle when a robot body is in a fixed posture according to the present invention;

FIG. 7 is a schematic diagram of climbing stairs when the robot body is in a fixed posture according to the present invention; and

FIG. 8 is a schematic diagram of turning around in place when the robot body is in a fixed posture.

In which: 1—robot body; 2—wheel; 3—first power unit; 4—leg unit; 5—second power unit; 6—leg end portion; 7—third power unit; 41—thigh base; 42—thigh linkage; 43—support seat; 44—pin shaft seat; 45—thigh cover plate.

### DETAILED DESCRIPTION OF THE EMBODIMENTS

In order to make the purpose, technical solutions, and advantages of the present invention clearer, the present invention will be further described below in conjunction with the accompanying drawings and embodiments. It should be understood that the specific embodiments described herein are only used to explain the present invention, but are not intended to limit the present invention.

On the contrary, the present invention covers any alternatives, modifications, equivalent methods and solutions defined by the claims within the spirit and scope of the present invention. Further, in order to enable the public to have a better understanding of the present invention, some specific details are described in detail in the following detailed description of the present invention. Those skilled in the art can fully understand the present invention without the description of these details.

It should be noted that when two elements are “fixedly connected”, “fixed”, “rotatably connected”, or “swingingly connected”, the two elements may be directly connected or be connected via an intermediate element. On the contrary, when an element is referred to as being “directly on” another element, there is no intermediate element. The terms “vertical”, “up”, “down”, and similar expressions used herein are for descriptive purposes only.

Unless otherwise defined, all technical and scientific terms used herein have the same meanings as those commonly understood by those skilled in the technical field of the present invention. The terms used herein are only for the purpose of describing specific embodiments and are not intended to limit the present invention. The term “and/or” as used herein includes any and all combinations of one or more related listed items.

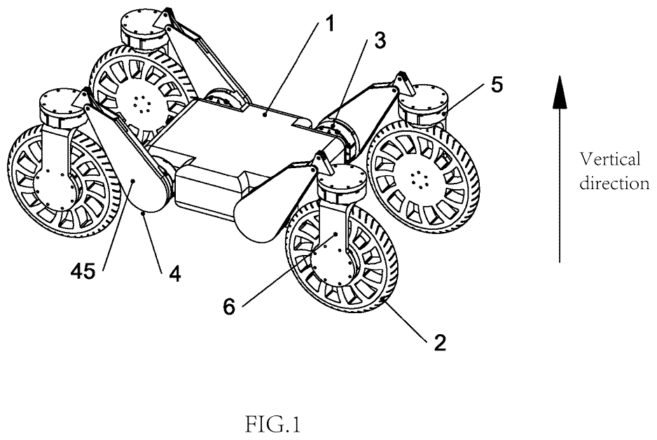

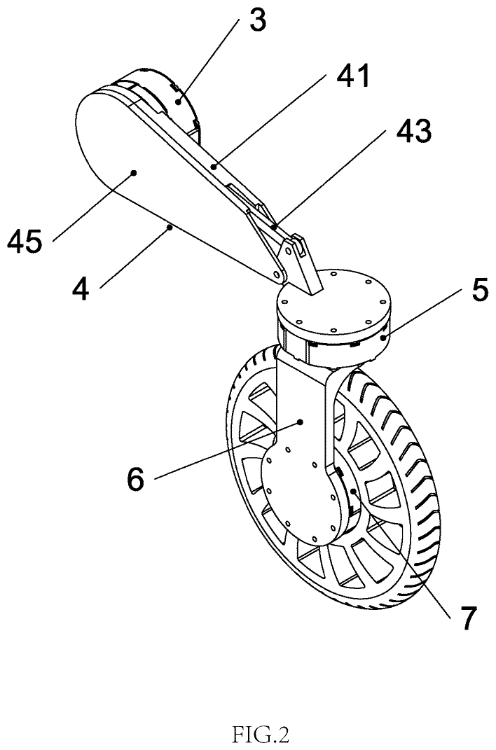

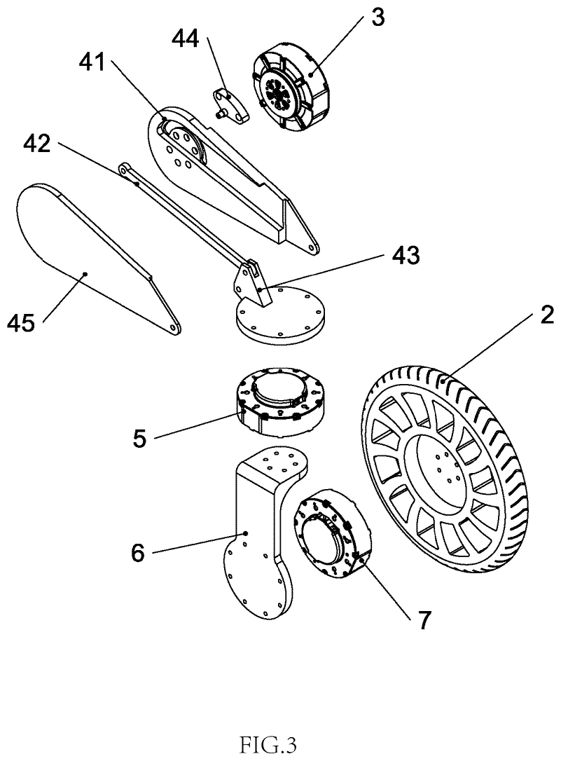

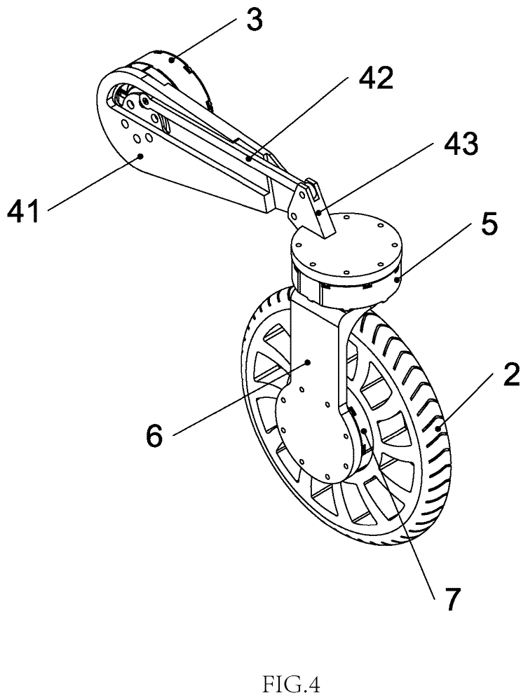

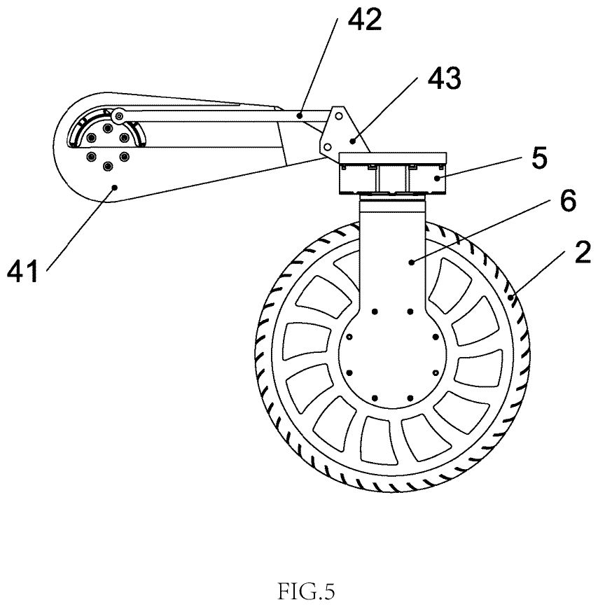

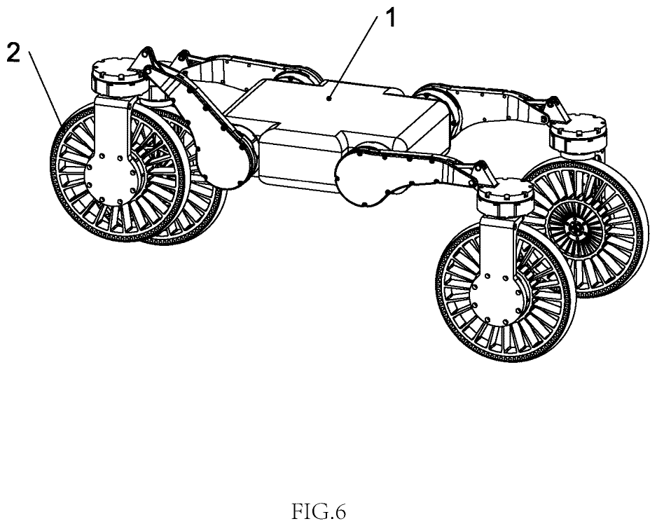

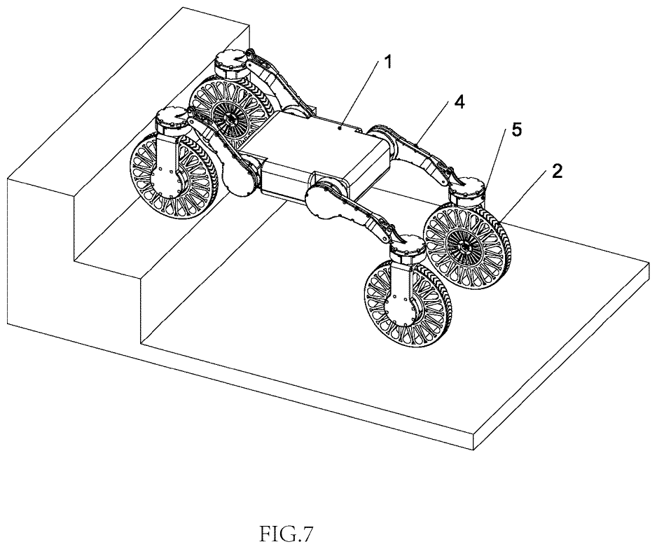

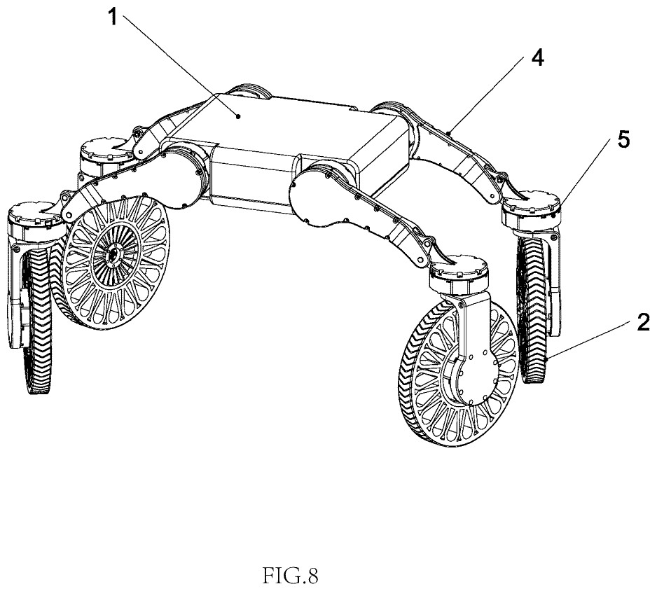

As shown in FIGS. 1-8, a specific embodiment of a mobile device according to the present invention is as follows:

The mobile device includes a robot body 1 and a wheel 2.

A first power unit 3 and a leg unit 4 are provided between the robot body 1 and the wheel 2.

The first power unit 3 is provided with a rotating shaft I and has a fixed end provided on the robot body 1, the rotating shaft I being fixed to the leg unit 4 and capable of driving the leg unit 4 to swing relative to the robot body 1.

The leg unit 4 is provided with at least one rod member or/and plate member or/and support, and is equipped with the wheel 2.

The wheel 2 can be lifted upward when the leg unit 4 swings upward, to avoid an obstacle and enable the robot body 1 to maintain a desired position and posture.

In the present invention, after continuous exploration and experimentation, the first power unit 3 is provided on the robot body to control the leg unit 4 to swing up and down vertically, thereby driving the wheel 2 to move up and down vertically, enabling the robot body to maintain a fixed posture as far as possible through up-down movement of the wheel 2 when encountering an obstacle or a depression during movement, thereby reducing shaking of the robot body 1. The solution is simple and practical, and facilitates the production and manufacture.

Furthermore, the wheel 2 in the present invention can be lifted independently, so that the posture of the robot body 1 can be fixed in any state, enabling the present invention to adapt to different complex terrains such as stairs, grass, slopes, and obstacles.

A specific embodiment of additionally providing a leg end portion 6 according to the present invention is as follows:

The leg unit 4 is connected to the wheel 2 through the leg end portion 6, forming a multi-joint structure.

The legend portion 6 is a shank support, which is mounted on an outer side of the wheel 2.

The shank support has high structural strength, making it suitable for various scenarios. The shank support is mounted on the outer side of the wheel 2 to effectively increase space between two opposing wheels 2, facilitating free rotation of the two wheels 2, avoiding mutual interference, and thereby making the structure of the present invention compact and small in size.

A specific embodiment of additionally providing a second power unit 5 according to the present invention is as follows:

The second power unit 5 is mounted between the leg unit 4 and the legend portion 6. The second power unit 5 is provided with a rotating shaft II and has a fixed end mounted on the leg unit 4, the rotating shaft II being fixed to the leg end portion 6.

The second power unit 5 is provided at the knee joint of each leg, to drive 360-degree omnidirectional steering of the wheel 2, avoiding the limitation of a steering angle imposed by a conventional steering mechanism, and thereby making the movement more flexible.

A specific embodiment of additionally providing a third power unit 7 according to the present invention is as follows:

The third power unit 7 is mounted between the leg end portion 6 and the wheel 2.

The third power unit 7 is provided with a rotating shaft III and has a fixed end mounted on the leg end portion 6, the rotating shaft III being fixed to the wheel 2.

The third power unit 7 is provided at the wheel 2 to directly convert the output of the third power unit 7 into the kinetic energy for advancing of the wheel 2, resulting in higher transmission efficiency.

A specific embodiment of orientations of the power units according to the present invention is as follows:

The axis of rotation of the second power unit 5 is perpendicular to the axis of rotation of the first power unit 3.

The axis of rotation of the third power unit 7 is perpendicular to the axis of rotation of the second power unit 5, enabling the wheel 2 to rotate 360 degrees and to be lifted upward.

Through cooperation between the first power unit 3 at the hip joint, the second power unit 5 at the knee joint, and the third power unit 7 driving the rotation of the wheel 2, the posture of the robot body 1 can be fixed in any state, enabling adaptation to different complex terrains such as stairs and grass.

A preferred embodiment of a self-stabilizing omnidirectional mobile robot according to the present invention is as follows:

The self-stabilizing omnidirectional mobile robot includes a robot body 1, a power system, and a wheel 2, wherein the power system includes a first power unit 3, a leg unit 4, a second power unit 5, a leg end portion 6, and a third power unit 7 connected in sequence; the first power unit 3 is provided on the robot body 1 to drive the leg unit 4 to swing in a vertical plane relative to the robot body 1; the third power unit 7 is provided on the leg end portion 6 to drive the wheel 2 to rotate; the second power unit 5 drives the leg end portion 6 to rotate vertically along the axis thereof, so as to steer the wheel 2; when the wheel 2 encounter an obstacle, the leg unit 4 swings upward, and the wheel 2 is vertically lifted upward, to enable the robot body 1 to maintain a specific position and posture.

A specific embodiment of a structure of the leg unit 4 according to the present invention is as follows:

The leg unit 4 includes a thigh base 41, a thigh linkage 42, and a support seat 43, wherein the support seat 43 is fixed on a housing of the second power unit 5 and hinged to the thigh base 41; an output end of the first power unit 3 is fixedly connected to the thigh base 41; one end of the thigh linkage 42 is hinged to a housing of the first power unit 3 or the robot body 1, and the other end is hinged to the support seat 43; and a thigh cover plate 45 is fitted to a side of the thigh base 41.

The thigh base 41, the thigh linkage 42, and the support seat 43 form a four-bar linkage driving the wheel 2 to move up and down, and a steering axis of the wheel 2 remains vertical relative to the ground, to enable the robot body 1 to maintain a specific position and posture.

A specific embodiment of a structure of the first power unit 3 according to the present invention is as follows:

A pin shaft seat 4 is fixed on the housing of the first power unit 3; and the thigh linkage 42 is rotatably connected to the first power unit 3 or the robot body 1 through the pin shaft seat 4.

A specific embodiment of structures of the power units according to the present invention is as follows:

The first power unit 3 and/or the second power unit 5 and/or the third power unit 7 include a motor unit and a reduction unit, the housing of the second power unit 5 is fixed on the legend portion 6, and a housing of the third power unit 7 is provided coaxially with the center of rotation of the wheel 2.

A specific embodiment of a structure of the robot body 1 according to the present invention is as follows:

At least three sets of power systems and wheels 2 are arranged on the robot body.

The present invention provides the self-stabilizing omnidirectional mobile robot, wherein the first power unit 3 is provided at the hip joint of each leg to control the leg unit to swing up and down vertically, thereby driving the wheel 2 to move up and down vertically, enabling the robot body 1 to effectively maintain a fixed posture through up-down movement of the wheel 2 when encountering an obstacle or a depression during movement; the second power unit 5 is provided at the knee joint of each leg, to drive 360-degree omnidirectional steering of the wheel 2, avoiding the limitation of a steering angle imposed by a conventional steering mechanism and thereby making the movement more flexible; and the third power unit 7 is provided at the wheel 2, directly converting output of the third power unit 7 into kinetic energy for advancing of the wheel 2, resulting in higher transmission efficiency. Through cooperation between the first power unit 3 at the hip joint, the second power unit 5 at the knee joint, and the third power unit 7 driving the rotation of the wheel 2, the posture of the robot body can be fixed in any state, enabling adaptation to different complex terrains such as stairs and grass.

In the present application, the fixation or fixed connection may be screw connection, welding, riveting, inserting, or connection achieved via a third component, which can be selected by those skilled in the art according to an actual situation.

Finally, it should be noted that the above embodiments are only used to illustrate the technical solutions of the present invention, rather than to limit them. Although the present invention has been described in detail with reference to the above embodiments, those skilled in the art should understand that the specific embodiments of the present invention may still be modified or replaced by equivalents, and any modifications or equivalent replacements that do not deviate from the spirit and scope of the present invention shall be covered by the protection scope of claims of the present invention.

1. A self-stabilizing omnidirectional mobile robot, comprising a robot body a power system, and a wheel, wherein the power system comprises a first power unit, a leg unit, a second power unit, a leg end portion, and a third power unit connected in sequence;
the first power unit is provided with a rotating shaft I and a fixed end I;
one of the rotating shaft I and the fixed end I is provided on the robot body, and the other drives the leg unit to swing relative to the robot body in a vertical plane;
the third power unit is provided with a rotating shaft III and a fixed end III; one of the rotating shaft III and the fixed end III is provided on the leg end portion, and the other drives the wheel to rotate;
the second power unit is provided with a rotating shaft II for driving the leg end portion to rotate vertically along the axis thereof, so as to steer the wheel; and
when the wheel encounters an obstacle, the leg unit is capable of swinging up and down, causing the wheel to swing up and down vertically.

2. The self-stabilizing omnidirectional mobile robot according to claim 1, wherein the leg unit comprises a thigh base, a thigh linkage, and a support seat, wherein the support seat is fixed on a housing of the second power unit and hinged to the thigh base an output end of the first power unit is fixedly connected to the thigh base, one end of the thigh linkage is hinged to a housing of the first power unit or the robot body, and the other end is hinged to the support seat; the thigh base, the thigh linkage, and the support seat form a four-bar linkage driving the wheel to move up and down, and a steering axis of the wheel remains vertical relative to the ground.

3. The self-stabilizing omnidirectional mobile robot according to claim 2, wherein a pin shaft seat is fixed on the housing of the first power unit; the thigh linkage is rotatably connected to the first power unit or the robot body through the pin shaft seat; and a thigh cover plate is fitted to a side of the thigh base.

4. The self-stabilizing omnidirectional mobile robot according to claim 1, wherein the first power unit and/or the second power unit and/or the third power unit comprise a motor unit and a reduction unit, the housing of the second power unit is fixed on the leg end portion, and a housing of the third power unit is provided coaxially with the center of rotation of the wheel.

5. The self-stabilizing omnidirectional mobile robot according to claim 4, wherein at least three sets of power systems and wheels are arranged on the robot body.

6. A mobile device, comprising a robot body and a wheel, wherein
a first power unit and a leg unit are provided between the robot body and the wheel;
the first power unit is provided with a rotating shaft I and a fixed end I;
one of the rotating shaft I and the fixed end I is provided on the robot body, and the other is fixed to the leg unit and capable of driving the leg unit to swing relative to the robot body;
the leg unit is provided with at least one rod member or/and plate member or/and support, and is equipped with the wheel; and
the wheel is capable of swinging up and down when the leg unit swings up and down.

7. The mobile device according to claim 6, wherein
the leg unit is connected to the wheel through a leg end portion, forming a multi-joint structure; and
the legend portion is a rod member or/and plate member or/and support, which is mounted on an inner side, an outer side, or two sides of the wheel.

8. The mobile device according to claim 7, wherein
a second power unit is mounted between the leg unit and the leg end portion; and
the second power unit is provided with a rotating shaft II and has a fixed end mounted on the leg unit, the rotating shaft II being fixed to the leg end portion.

9. The mobile device according to claim 8, wherein
a third power unit is mounted between the leg end portion and the wheel; and
the third power unit is provided with a rotating shaft III and has a fixed end mounted on the leg end portion, the rotating shaft III being fixed to the wheel.

10. The mobile device according to claim 9, wherein
the axis of rotation of the second power unit is perpendicular to the axis of rotation of the the axis of rotation of the third power unit is perpendicular to the axis of rotation of the second power unit, enabling the wheel to rotate 360 degrees and swing up and down.
